(19) United States
(12) Patent Application Publication
(10) Pub. No.: US 2012/0080138 A1
(43) Pub. Date: Apr. 5, 2012

(54) METHOD OF PROCESSING PLATE-SHAPED BODY HAVING RUGGED SURFACE

(75) Inventor: Leng Chye Yew, Singapore (SG)

(73) Assignee: DISCO CORPORATION, Tokyo (JP)

(21) Appl. No.: 13/240,617

(22) Filed: Sep. 22, 2011

(30) Foreign Application Priority Data
Oct. 1, 2010 (JP) 2010-223470

(51) Int. Cl. B32B 37/02; B32B 37/14; B32B 38/10; B32B 37/12

(52) U.S. Cl. 156/153; 156/247

(57) ABSTRACT

A method of processing a plate-shaped body, for grinding or polishing the back side of a plate-shaped body having ruggedness on the face side thereof, includes: a coating step of coating the face side of the plate-shaped body with a water-soluble protective film; a protective tape adhering step of adhering a protective tape composed of a substrate and a paste layer to the face side of the plate-shaped body coated with the water-soluble protective film so as to bury the ruggedness in the paste layer; a processing step of holding the protective tape side of the plate-shaped body, with the protective tape adhered thereto, by a chuck table and grinding or polishing the back side of the plate-shaped body; and a removing step of peeling, after the processing step, the protective tape from the face side of the plate-shaped body and removing the water-soluble protective film.

### BACKGROUND OF THE INVENTION

1. Field of the Invention

The present invention relates to a method of processing a plate-shaped body, for grinding or polishing a back side of a plate-shaped body having ruggedness (bumpiness, or projections and recesses) on a face side thereof.

2. Description of the Related Art

In a semiconductor device manufacturing process, planned dividing lines called streets are formed in a grid pattern on a surface (face-side surface) of a wafer composed of silicon or compound semiconductor, and such devices as ICs and LSIs are formed in regions demarcated by the planned dividing lines. The wafer is thinned to a predetermined thickness by grinding and polishing the back side thereof and is then divided along the planned dividing lines, whereby individual semiconductor devices are manufactured. In order that the devices formed on the face side of the wafer are protected during grinding or polishing, a protective tape, for example, the one that is disclosed in Japanese Patent Laid-open No. Hei 11-307620 is adhered to the face side of the wafer. The wafer is held by a chuck table of a grinding apparatus or a polishing apparatus through the protective tape therebetween, and the exposed back side of the wafer is ground or polished.

In recent years, as a technology for realizing reductions in weight, thickness and size of semiconductor devices, a mounting technology called flip chip bonding has been put to practical use. In this mounting technology, a plurality of metallic projections called bumps are formed on the surfaces of devices, and the bumps are made to face electrodes formed on a wiring board and are bonded directly to the electrodes. However, if the protective tape is adhered to a wafer having tall bumps, for example, bumps of 200 μm in height, gaps would be generated between the protective tape and the wafer, resulting in a structure in which the wafer is fixed to the protective tape by the bumps only.

When the back side of the wafer is ground in this condition, therefore, stressed are exerted on the bump portions of the wafer, probably resulting in breakage of the wafer. In order to solve this problem, for example, a grinding method in which a protective tape having a paste layer with a thickness greater than the height of the bumps is adhered to the face side of the wafer before grinding is disclosed in Japanese Patent Laid-open No. Hei 10-50642.

### SUMMARY OF THE INVENTION

However, if a protective tape with a very thick paste layer is used so as to fill up the spaces between the bumps with the paste, there would be a problem that even when the protective tape is peeled from the wafer after the grinding, the paste layer having filled up the spaces between the bumps are left on the surface (face side) of the wafer.

Accordingly, it is an object of the present invention to provide a method of processing a plate-like body such as a wafer having ruggedness (bumpiness, or projections and recesses) on the face side thereof by which a paste of a protective tape can be prevented from being left upon removal of the protective tape.

In accordance with an aspect of the present invention, there is provided a method of processing a plate-shaped body, for grinding or polishing a back side of a plate-shaped body having ruggedness on a face side, including: a coating step of coating the face side of the plate-shaped body with a water-soluble protective film; a protective tape adhering step of adhering a protective tape which has a substrate and a paste layer to the face side of the plate-shaped body coated with the water-soluble protective film so as to bury the ruggedness in the paste layer; a processing step of holding the protective tape side of the plate-shaped body, with the protective tape adhered thereto, by a chuck table and grinding or polishing the back side of the plate-shaped body; and a removing step of peeling, after the processing step, the protective tape from the face side of the plate-shaped body and removing the water-soluble protective film.

Preferably, the method of processing the plate-shaped body further includes a second protective tape adhering step of adhering a second protective tape harder than the protective tape onto the protective tape, after the protective tape adhering step and before the processing step.

In the processing method pertaining to the present invention, the face side of the plate-shaped body such as a wafer is preliminarily coated with the water-soluble protective film. Thereafter, the protective tape is adhered onto the water-soluble protective film and the back side of the plate-shaped body is processed, after which the protective tape is peeled off, and, further, the water-soluble protective film is removed by dissolving it in water. Therefore, the paste layer of the protective tape is prevented from remaining on the surface (face side) of the wafer.

In addition, the second protective tape harder than the protective tape is adhered onto the protective tape having the thick paste layer, whereby the surface of the second protective tape can be made flat. Therefore, at the time of grinding or polishing, the surface of the second protective tape is suction held by a chuck table, whereby the back side of the plate-shaped body can be planarized with high accuracy.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a semiconductor wafer suitable for application thereto of the processing method pertaining to the present invention;

FIG. 2 is an enlarged sectional view of the semiconductor wafer shown in FIG. 1;

FIG. 3 is a sectional view showing a condition in which the face side (face-side surface) of the semiconductor wafer is coated with a water-soluble protective film;

FIG. 4 is a partly broken perspective view of a protecting film coating apparatus;

FIG. 5 is a vertical sectional view of the protective film coating apparatus in the condition in which a spinner table is raised and the wafer is held by the spinner table;

FIG. 6 is a vertical sectional view of the protective film coating apparatus in the condition in which a water-soluble resin is to be applied to the face side of the wafer;

FIG. 7 is a sectional view showing a condition in which a first protective tape is adhered to the face side of the wafer in such a manner as to bury the bumps;

FIG. 8 is a sectional view showing a condition in which a second protective tape harder than the first protective tape is adhered onto the first protective tape;

FIG. 9A is a perspective view showing a grinding step;

FIG. 9B is a side view of the same; and

FIG. 10 is a vertical sectional view of the protective film coating apparatus showing a washing step (protective film removing step).

### DETAILED DESCRIPTION OF THE PREFERRED EMBODIMENT

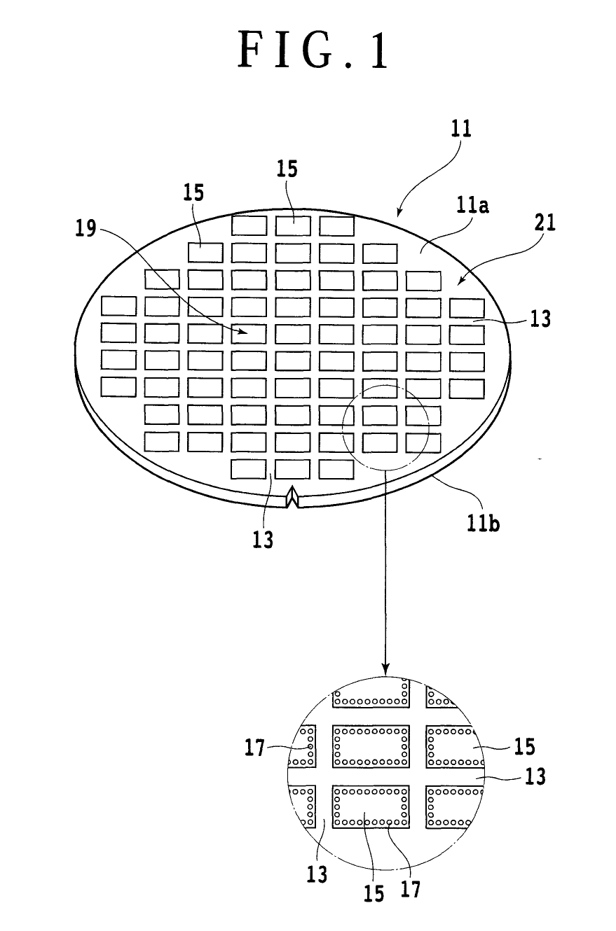

Now, an embodiment of the present invention will be described in detail below referring to the drawings. Referring to FIG. 1, there is shown a perspective view of a semiconductor wafer 11 suitable for being processed (ground) by the processing method pertaining to the present invention. The semiconductor wafer 11 has a face side (face-side surface) 11a and a back side (back-side surface) 11b. A plurality of streets 13 in an orthogonally intersecting form are formed on the face side 11a, and devices 15 are formed respectively in regions demarcated by the streets 13. As shown in an enlarged view in FIG. 1, a plurality of projection-shaped bumps 17 are formed along the four edges of each of the devices 15. Since each of the devices 15 is formed with the bumps 17 at the four edges thereof, the semiconductor wafer 11 has a bump formed region 19 in which the bumps 17 are formed and a bump unformed region 21 surrounding the bump formed region 19.

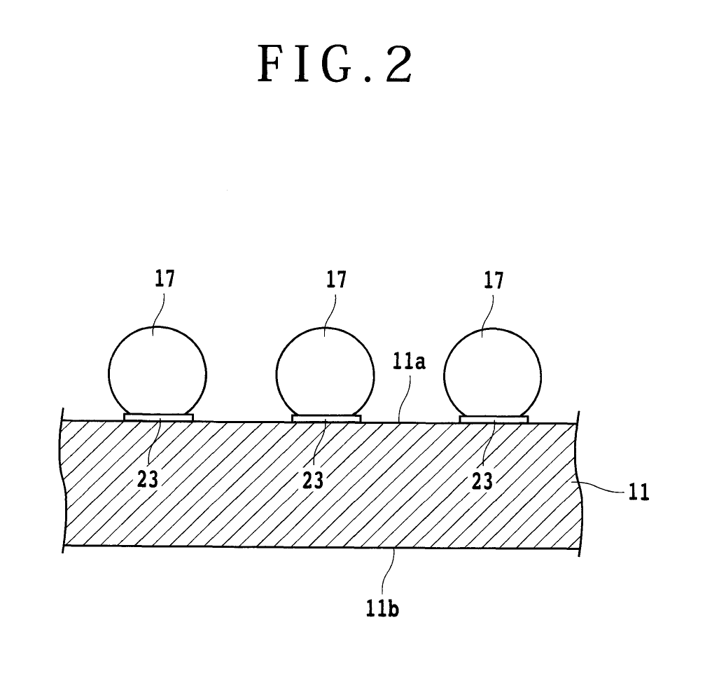

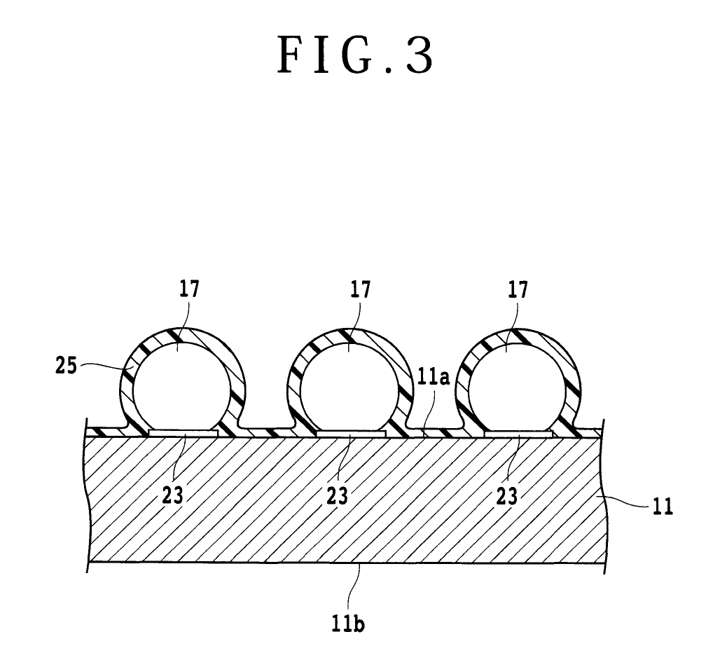

As shown in an enlarged sectional view of FIG. 2, each of the bumps 17 is connected to an electrode 23 of the device 15. The height of the bumps 17 is, for example, 250 μm. In the processing method pertaining to the present invention, as shown in FIG. 3, a coating step of coating the face side 11a of the wafer 11 with a water-soluble protective film 25 is first carried out. The water-soluble protective film 25 is formed by use of a liquid resin, which is desirably a water-soluble resist such as PVA (polyvinyl alcohol), PEG (polyethylene glycol) and PEO (polyethylene oxide).

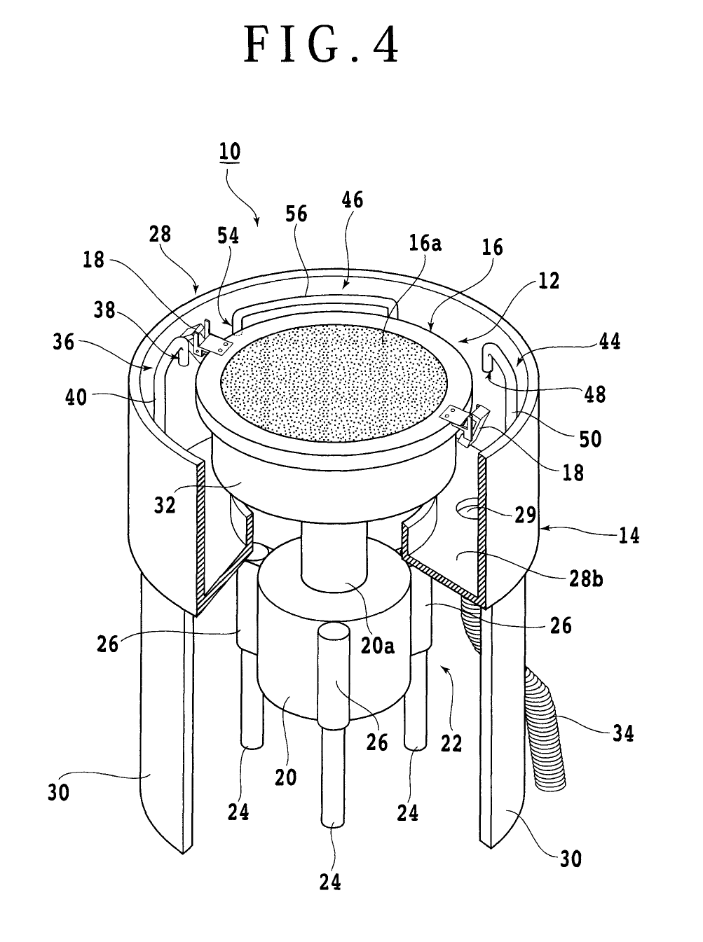

A protective film coating apparatus 10 suitable for use to carry out the protective film coating step will be described referring to FIGS. 4 to 6. Referring first to FIG. 4, there is shown a partly broken perspective view of the protective film coating apparatus 10. The protective film coating apparatus 10 has a spinner table mechanism 12, and a washing water receiving mechanism 14 disposed to surround the spinner table mechanism 12. The spinner table mechanism 12 includes spinner table (holding table) 16, an electric motor 20 for rotationally driving the spinner table 16, and a support mechanism 22 for supporting the electric motor 20 in a vertically movable manner.

The spinner table 16 has a suction chuck (holding section) 16a formed from a porous material, and the suction chuck 16a communicates with suction means which is not shown. Therefore, the spinner table 16 suction holds the wafer 11 on the suction chuck 16a by a process in which the wafer 11 is placed on the suction chuck 16a and a negative pressure is applied thereto by the suction means being not shown. The spinner table 16 is equipped with a pair of clamps 18 of a pendulum type, and the clamps 18 are oscillated by centrifugal forces when the spinner table 16 is rotated. In the processing method pertaining to the present invention, however, it is unnecessary to use the clamps 18, so that the clamps 18 can be omitted.

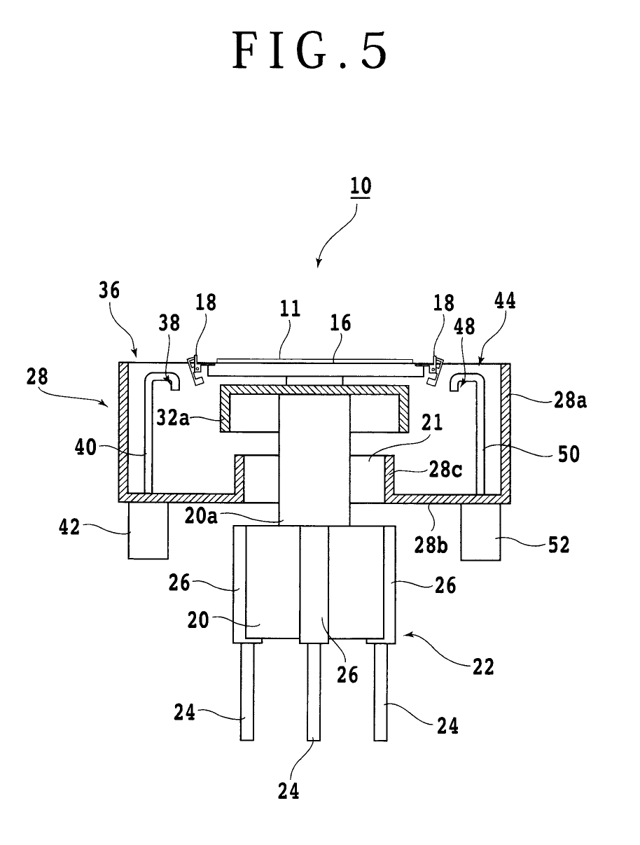

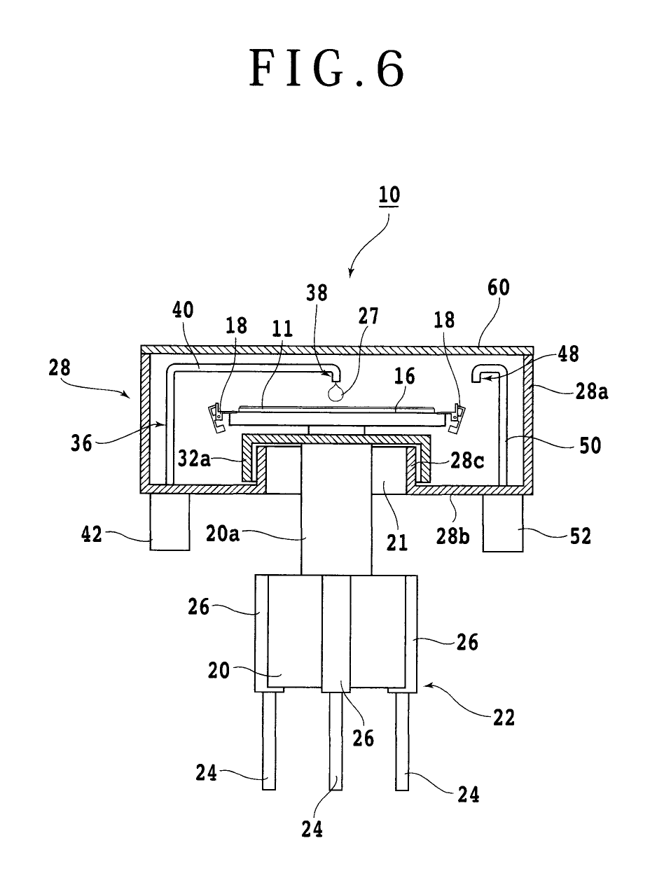

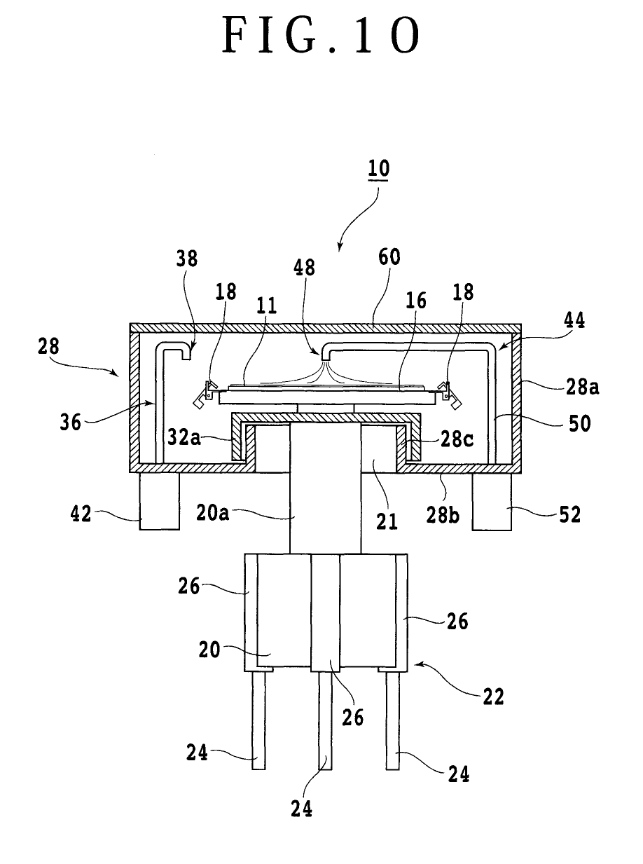

The spinner table 16 is connected to an output shaft 20a of the electric motor 20. The support mechanism 22 includes a plurality of (in this embodiment, three) support legs 24, and a plurality of (in this embodiment, three) air cylinders 26 which are connected respectively to the support legs 24 and are attached to the electric motor 20. With the air cylinders 26 operated, the support mechanism 22 thus configured can position the electric motor 20 and the spinner table 16 to a wafer feeding-in/out position which is a raised position shown in FIG. 5 and an operating position which is a lowered position shown in FIGS. 6 and 10.

The washing water receiving mechanism 14 includes a washing water receiving vessel 28, three support legs 30 (only two of them are shown in FIG. 4) for supporting the washing water receiving vessel 28, and a cover member 32 mounted to the output shaft 20a of the electric motor 20. As shown in FIG. 5, the washing water receiving vessel 28 includes a hollow cylindrical outside wall 28a, a bottom wall 28b, and an inside wall 28c. The bottom wall 28b is provided in a central portion thereof with a hole 21 in which to insert the output shaft 20a of the electric motor 20, and the inside wall 28c is so formed as to project upward from the periphery of the hole 21.

In addition, as shown in FIG. 4, the bottom wall 28b is provided with a waste liquid drain hole 29, to which is connected a drain hose 34. The cover member 32 is formed to be circular plate-like in shape, and has a cover section 32a projecting downward from the outer peripheral edge of the cover member 32. In the cover member 32 thus configured is so positioned, when the electric motor 20 and the spinner table 16 are positioned in the operating position shown in FIGS. 6 and 10, the cover section 32a is positioned on the outside of the inside wall 28c, constituting the washing water receiving vessel 28, in such a manner as to overlap with the inside wall 28c, with a gap therebetween.

The protective film coating apparatus 10 has applying means 36 for applying a water-soluble resin to the face side 11a of the wafer 11 which is held by the spinner table 16 and which is to be processed. The applying means 36 includes a water-soluble resin supplying nozzle 38 for supplying a water-soluble resin toward the face side 11a of the wafer 11 held by the spinner table 16, a roughly L-shaped arm 40 for supporting the water-soluble resin supplying nozzle 38, and an electric motor 42 which is capable of normal rotation and reverse rotation and which oscillates the water-soluble resin supplying nozzle 38 supported by the arm 40. The water-soluble resin supplying nozzle 38 is connected through the arm 40 to a water-soluble resin supply source which is not shown.

The protective film coating apparatus 10 functions also as a washing apparatus for the wafer 11 having been processed. Therefore, the protective film coating apparatus 10 has washing water supplying means 44 for washing the processed wafer held by the spinner table 16, and air supplying means 46. The washing water supplying means 44 includes a washing water nozzle 48 for jetting washing water toward the processed (ground) wafer 11 held by the spinner table 16, an arm 50 for supporting the washing water nozzle 48, and an electric motor 52 which is capable of normal rotation and reverse rotation and which oscillates the washing water nozzle 48 supported by the arm 50. The washing water nozzle 48 is connected through the arm 50 to a washing water supply source which is not shown.

The air supplying means 46 includes an air nozzle 54 for jetting air toward the washed wafer 11 held by the spinner table 16, an arm 56 for supporting the air nozzle 54, and an electric motor (not shown) which is capable of normal rotation and reverse rotation and which oscillates the air nozzle 54 supported by the arm 56. The air nozzle 54 is connected through the arm to an air supply source which is not shown.

Now, operation of the protective film coating apparatus 10 configured as above will be described below. As shown in FIG. 5, the wafer 11 with its back side 11b down is placed on the spinner table 16 of the protective film coating apparatus 10 positioned in the wafer feeding-in/out position, and the wafer 11 is suction held by the suction chuck 16a. In this case, the water-soluble resin supplying nozzle 38, the washing water nozzle 48 and the air nozzle 54 are positioned in a stand-by position separate from the upper side of the spinner table 16, as shown in FIG. 5. When the wafer 11 is suction held by the spinner table 16, the air cylinders 26 are operated to position the spinner table 16 into the operating position shown in FIG. 6.

After the wafer 11 is thus positioned in the operating position, the protective film coating step is carried out in which the face side 11a of the wafer 11 is coated with a protective film by applying the water-soluble resin. In order to carry out the protective film coating step, the spinner table 16 is rotated at 10 to 100 rpm (preferably, 30 to 50 rpm) as shown in FIG. 6, and, in this condition, the water-soluble resin 27 is dropped from the water-soluble resin supplying nozzle 38 to a central region of the face side 11a of the wafer 11. Reference symbol 60 denotes a lid. Since the spinner table 16 is being rotated, the face side 11a of the wafer 11 is spin coated with the water-soluble resin 27 dropped, resulting in that the water-soluble protective film 25 is formed on the face side 11a of the wafer 11 in such a manner as to envelop the bumps 17, as shown in FIG. 3. The thickness of the water-soluble protective film 25 is preferably about 5 to 10 μm.

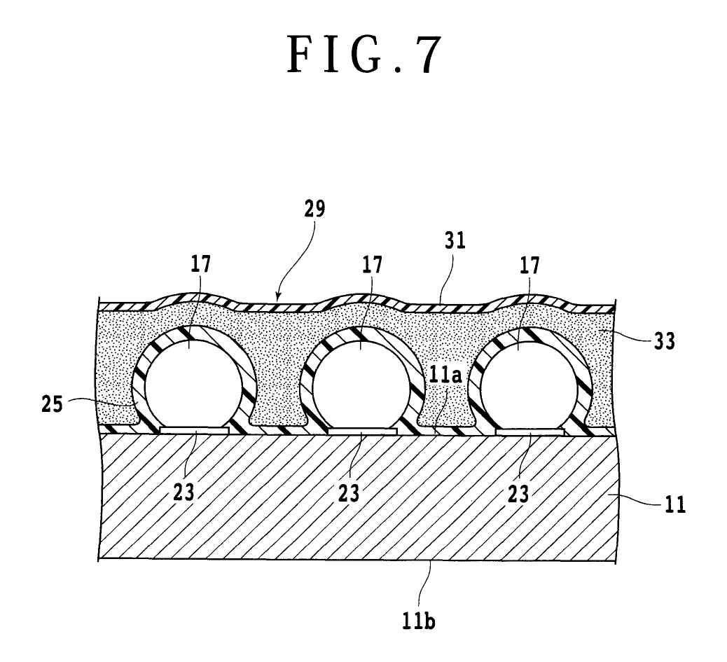

After the face side 11a of the wafer 11 is coated with the water-soluble protective film 25 by the protective film coating step, the protective tape adhering step is conducted in which the first protective film 29 is adhered to the face side 11a of the wafer 11, as shown in FIG. 7. The first protective tape 29 has a configuration in which an acrylic or rubber paste layer 33 is disposed on a substrate 31 based on polyolefin. The first protective tape 29 has the paste layer 33 having a thickness (for example, 300 μm) greater than the height of 250 μm of the bumps 17. In the protective tape adhering step, the first protective tape 29 is adhered to the face side 11a of the wafer 11 in such a manner as to bury the bumps 17 in the paste layer 33.

When the first protective tape 29 having the thick paste layer 33 is adhered to the face side 11a of the wafer 11 in such a manner as to bury the bumps as shown in FIG. 7, the substrate 31 does not become flat but is accompanied by some undulation. Therefore, when the first protective tape 29 side is suction held by a chuck table of a grinding apparatus and the back side 11b of the wafer 11 is ground, it may be impossible by grinding to achieve flattening (planarization) of the wafer 11 with high accuracy.

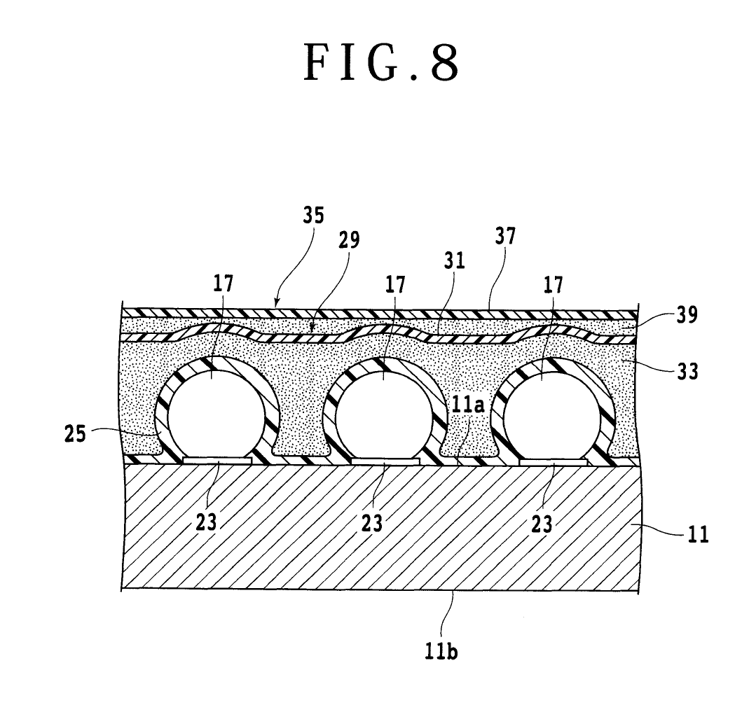

In view of this, in the processing method pertaining to the present invention, it is preferable to carry out a second protective tape adhering step of adhering a second protective tape 35 onto the first protective tape 29, as shown in FIG. 8. The second protective tape 35 has a configuration in which an acrylic or rubber paste layer 39 is disposed on a hard substrate 37 of PET (polyethylene terephthalate) or the like. Since the substrate 37 is harder than the substrate 31 of the first protective tape 29, adhesion of the second protective tape 35 onto the first protective tape 29 results in that the undulation of the first protective tape 29 is absorbed by the paste layer 39 of the second protective tape 35, whereby the substrate 37 can be made flat.

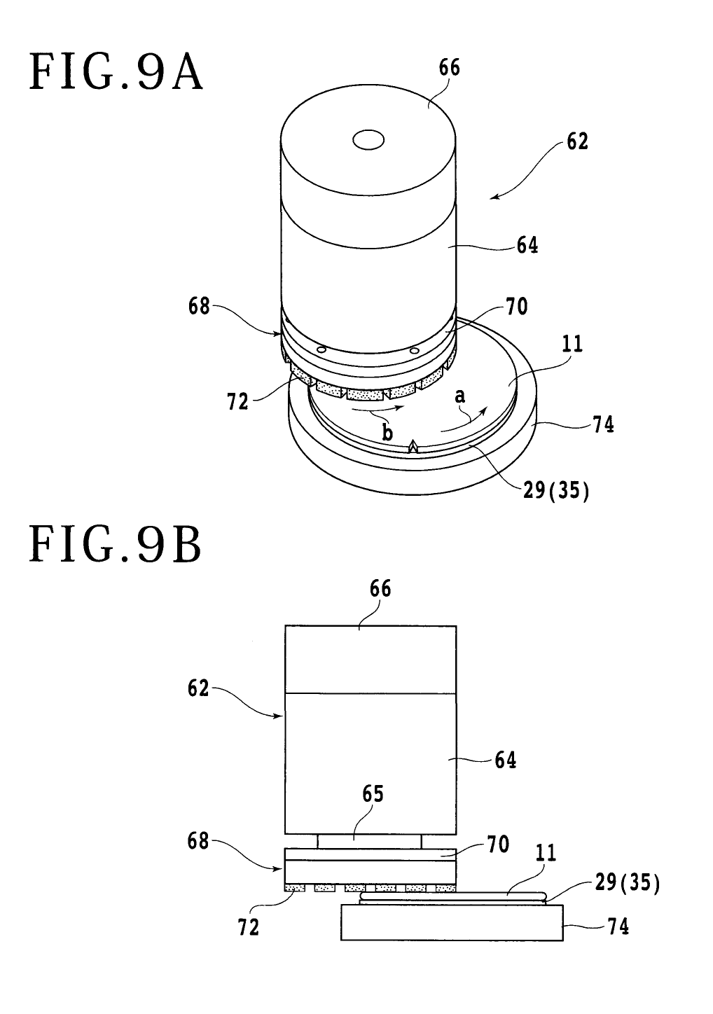

In a preferable embodiment of the present invention, therefore, grinding of the back side 11b of the wafer 11 is conducted in the condition in which the first protective tape 29 and the second protective tape 35 are adhered to the face side 11a of the wafer 11. This grinding method will be described referring to FIGS. 9A and 9B. FIG. 9A is a perspective view showing the grinding step, and FIG. 9B shows a side view of FIG. 9A. A grinding unit 62 includes a housing 64, a spindle 65 rotatably contained in the housing 64, a motor 66 for rotationally driving the spindle 65, a wheel mount 70 fixed to the tip of the spindle 65, and a grinding wheel 68 which is demountably mounted to the wheel mount 70 and having a plurality of grindstones 72 firmly attached to the lower end face thereof.

In the grinding step, the wafer 11 is suction held by the chuck table 74 of the grinding apparatus, through the first protective tape 29 and the second protective tape 35. Then, a grinding unit feeding mechanism is driven so that the grindstones 72 of the grinding wheel 68 are brought into contact with the back side 11b of the wafer 11. While grinding feed of the grinding wheel 68 is conducted at a predetermined grinding feed rate, the chuck table 74 is kept rotating in the direction of arrow a at a rate of, for example, 300 rpm, and in this condition, the grinding wheel 68 is rotated in the direction of arrow b at a rate of, for example, 6000 rpm, to perform grinding of the wafer 11. The grinding is conducted while measuring the thickness of the wafer 11 by a contact-type or non-contact-type thickness gauge, to finish the wafer 11 to a predetermined thickness.

In this embodiment, the first protective tape 29 and the second protective tape 35 are adhered to the face side 11a of the wafer 11 so as to make the surface of the second protective tape 35 flat, before suction holding the second protective tape 35 side by the chuck table 74 of the grinding apparatus. Therefore, when grinding of the back side 11b of the wafer 11 provided with the bumps is performed under this condition, the wafer can be made flat (planar) with high accuracy.

After the grinding step is conducted, the first and second protective tapes 29 and 35 are peeled from the face side 11a of the wafer 11. Since the paste layer 33 of the first protective tape 29 is very thick and the first protective tape 29 is adhered to the face side 11a of the wafer 11 in such a manner as to bury the bumps 17 in the paste layer 33, peeling of the first protective tape 29 from the wafer 11 after the grinding results in that the paste constituting the paste layer 33 having filled up the spaces between the bumps 17 is left on the water-soluble protective film 25 coating the face side 11a of the wafer 11.

Taking this into account, in the processing method pertaining to the present invention, a protective film removing step is carried out in which the water-soluble protective film 25 is removed by dissolving it in water. The protective film removing step can be carried out by use of the protective film coating apparatus 10 which functions also as the washing apparatus. Specifically, as shown in FIG. 10, the back side 11b side of the wafer 11 is suction held by the spinner table 16, washing water composed of pure water and air is jetted from the washing water nozzle 48 connected to a pure water source and an air source, and, while keeping this condition, the wafer 11 is rotated at a low rotating speed (for example, 300 rpm), whereby the wafer 11 is washed. As a result, the protective film 25 formed to coat the face side 11a of the wafer 11 can be easily washed away, since the protective film 25 is formed from the water-soluble resin, and the residual paste layer 33 adhering onto the protective film 25 can be easily removed.

While the processing method pertaining to the present invention has been described with reference to an application thereof to a grinding method in the embodiment above, the present invention is not to be restricted to the embodiment, and is similarly applicable also to a polishing method for polishing the back side of the wafer 11. Furthermore, the work to be processed is not restricted to the wafer 11 having the bumps 17 thereon. For example, the present invention is similarly applicable also to other plate-shaped bodies having ruggedness on their face side, such as an optical device wafer in which epitaxial layers are formed on a face side of a sapphire substrate, exclusive of an outer peripheral region.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A method of processing a plate-shaped body, for grinding or polishing a back side of a plate-shaped body having ruggedness on a face side, comprising:
a coating step of coating the face side of the plate-shaped body with a water-soluble protective film;
a protective tape adhering step of adhering a protective tape which has a substrate and a paste layer to the face side of the plate-shaped body coated with the water-soluble protective film so as to bury the ruggedness in the paste layer;
a processing step of holding the protective tape side of the plate-shaped body, with the protective tape adhered thereto, by a chuck table and grinding or polishing the back side of the plate-shaped body; and
a removing step of peeling, after the processing step, the protective tape from the face side of the plate-shaped body and removing the water-soluble protective film.

2. The method according to claim 1, further comprising a second protective tape adhering step of adhering a second protective tape harder than said protective tape onto said protective tape, after the protective tape adhering step and before the processing step.

3. The method according to claim 1, wherein the ruggedness has a projecting electrode.
